(19) United States
(12) Patent Application Publication
(10) Pub. No.: US 2021/0142932 A1
(43) Pub. Date: May 13, 2021

(54) Chip Resistor Manufacturing Method

(71) Applicant: KOA Corporation, Ina-shi, Nagano (JP)

(72) Inventors: Kentaro MATSUMOTO, Ina-shi (JP); Natsuki IGUCHI, Ina-shi (JP)

(21) Appl. No.: 16/611,875

(22) PCT Filed: Mar. 13, 2018
(86) PCT No.: PCT/JP2018/009791

§ 371 Date: Nov. 8, 2019

(30) Foreign Application Priority Data
May 11, 2017 (JP) 2017-094736

(51) Int. Cl. H01C 17/242; H01C 17/00

(52) U.S. Cl. CPC H01C 17/242; H01C 17/006

(57) ABSTRACT

Regarding a chip resistor including a resistor provided with a first trimming groove for coarse adjustment and a second trimming groove for fine adjustment, the steps of setting the length of a first lateral direction cut part of the first trimming groove after L-shaped direction turning to be a certain length, setting coordinates of a trimming start point of the second trimming groove at a position which is constantly separated from a first vertical direction cut part of the first trimming groove only by a certain distance, and irradiating with a laser light from the coordinates toward a direction orthogonal to a direction between the electrodes are performed to form the second trimming groove which faces the first trimming groove and is oriented in the direction opposite to the orientation of the first trimming groove.

### TECHNICAL FIELD

The present invention relates to a method of manufacturing a chip resistor, in which trimming grooves are formed on a resistor provided on an insulating substrate to adjust a resistance value.

### BACKGROUND ART

Generally, a chip resistor is configured to mainly include a rectangular parallelepiped insulating substrate, a pair of front electrodes disposed on a front surface of the insulating substrate so as to face with each other with a predetermined interval therebetween, a pair of back electrodes disposed on a back surface of the insulating substrate so as to face with each other with a predetermined interval therebetween, end face electrodes for bridging the front electrodes and the corresponding back electrodes, a resistor for bridging the pair of front electrodes, and a protective film for covering the resistor.

In a case of manufacturing this type of a chip resistor, after multi-piece electrodes, resistors, protective films, etc. are collectively formed on a large-sized substrate, the large-sized substrate is divided along grid-like division lines (for example, division grooves) to obtain multi-piece chip resistors. The process of manufacturing this type of the chip resistor includes the step of printing and sintering resistance paste on one of the surfaces of the large-sized substrate to obtain multi-piece chip resistors, which makes it difficult to avoid occurrence of variation in resistance values of each resistor due to such as variation in thickness and bleeding during printing, or influence of temperature unevenness in a sintering furnace. Accordingly, a resistance value adjustment operation, in which trimming grooves are formed on each resistor in a state where they are on the large-sized substrate to set a resistance value to be a desired resistance value, is performed in the process above.

Generally, a resistance value adjustment method of this type of the resistor includes the following steps, namely, setting a resistance value of the resistor to be a resistance value little lower than a target resistance value in advance, and while measuring the resistance value of the resistor by bringing a probe for measurement into contact with both electrodes, irradiating the resistor with a laser light so as to form a trimming groove, so that the resistance value is rounded up and thus becomes the target resistance value. As the shape of the trimming groove, such as I-cut and L-cut are known, and when performing high-precision resistance value adjustment, such as II-cut, IL-cut, or double L-cut, in which two trimming grooves including one for coarse adjustment and the other for fine adjustment are combined, are adopted (Patent Literatures 1 and 2).

FIG. 6 illustrates a plan view of a chip resistor described in Patent Literature 1. As illustrated in FIG. 6, an L-cut shaped first trimming groove 101 and an I-cut shaped second trimming groove 102 are formed on a resistor 100. A resistance value of the resistor 100 is adjusted to be a target resistance value by these first trimming groove 101 for coarse adjustment and second trimming groove 102 for fine adjustment.

Here, a method of trimming this resistor will be described in the following. The trimming method includes the steps of, firstly, measuring an initial resistance value of the resistor 100 by bringing a probe into contact with a pair of electrodes 103, and setting and storing a first target resistance value lower than the target resistance value based on the initial resistance value. The next step is, while measuring a resistance value of the resistor 100 by bringing the probe into contact with the pair of electrodes 103, to perform irradiation of a laser light upwardly from the lower side of the resistor 100 so as to start vertical direction cutting of the first trimming groove 101. When the resistance value measured by the probe reaches the first target resistance value, the step of executing lateral direction cutting of the first trimming groove 101 is performed by turning an irradiation direction of the laser light to the left to form L-shape.

The next step is to perform irradiation of the laser light upwardly from the lower side of the resistor 100 at a predetermined position separated from a vertical direction cut part of the first trimming groove 101 to the right by a predetermined distance so as to start I-cutting (straight cutting) of the second trimming groove 102. When the resistance value measured by the probe reaches the target resistance value, irradiation to the resistor 100 with the laser light is stopped to finish the I-cutting of the second trimming groove 102, and thereby adjustment of the resistance value of the resistor 100 (trimming steps) is finished. In this way, by performing the steps of measuring an initial resistance value of the resistor 100 and setting the length of the vertical direction cut part of the first trimming groove 101 based on the initial resistance value, the length of the second trimming groove 102 does not exceed an L-turn position (tip of the vertical direction cut part) of the first trimming groove 101.

In this method of trimming a resistor described in Patent Literature 1, the length of the vertical direction cut part of the first trimming groove 101 is determined based on the initial resistance value of the resistor 100, the length of the I-cut part of the second trimming groove 102 does not become extremely long nor short, and thus a stable high-precision trimming can be performed regardless of variation in initial resistance values. However, at the tips of the first trimming groove 101 and the second trimming groove 102, microcracks occur and although the microcracks on the tip of the first trimming groove 101 has little influence on a resistance value since they extend toward a direction between the electrodes (lateral direction), the microcracks on the tip of the second trimming groove 102 has a great influence on the resistance value since they extend toward a direction (vertical direction) orthogonal to the direction between the electrodes. Furthermore, the microcracks on the tip of the second trimming groove 102 cause troubles in the electric characteristics and durability of the resistor 100.

In order to reduce the influence of the microcracks, in a method of trimming a resistor described in Patent Literature 2, as illustrated in FIG. 7, the L-cut shaped first trimming groove 101 and an L-cut shaped second trimming groove 104 are formed on the resistor 100 such that they face with each other. The method of trimming the resistor 100 in this case includes the steps of, firstly, while measuring a resistance value of the resistor 100 by bringing the probe into contact with the pair of electrodes 103, performing irradiation of a laser light upwardly from a predetermined position of the lower side of the resistor 100 so as to start vertical direction cutting of the first trimming groove 101. At the point which the measured resistance value reaches a value of several dozen percent of the target resistance value, the step of executing lateral direction cutting of the first trimming groove 101 by turning an irradiation direction of the laser light to the left to form. L-shape is started. Then, at the point which the measured resistance value reaches a resistance value obtained by subtracting several percent from the target resistance value, irradiation of the laser light is stopped to form the L-cut shaped first trimming groove 101. The first trimming groove 101 for coarse adjustment is formed by the steps described above, and with this first trimming groove 101, a value close to the target resistance value as a measured resistance value to a certain degree is obtained and the coarse adjustment of the resistance value is completed.

The next step is to perform irradiation of the laser light upwardly from the lower side of the resistor 100 at a position separated from a vertical direction cut part of the first trimming groove 101 to the left by a predetermined distance L so as to start vertical direction cutting of the second trimming groove 104. At the point which the resistance value measured by the probe reaches a resistance value obtained by subtracting, for example, one percent from the target resistance value, the step of executing lateral direction cutting of the second trimming groove 104 by turning an irradiation direction of the laser light to the right to form L-shape is started, and then at the point which the measured resistance value reaches the target resistance value, irradiation of the laser light is stopped so as to form the L-cut shaped second trimming groove 104. The first trimming groove 101 for coarse adjustment and the second trimming groove 104 for fine adjustment are formed by the steps described above, and when the trimming steps are finished at the point which the measured resistance value nearly reaches the target resistance value, the whole adjustment of the resistance value is completed.

In the method of trimming a resistor described in Patent Literature 2, after the L-cut shaped first trimming groove 101 is formed on the resistor 100 to coarsely adjust a resistance value, the L-cut shaped second trimming groove 104 is formed so as to face the first trimming groove 101, so that fine adjustment of the resistance value is performed. Accordingly, since both the microcracks occurring at the tip of the first trimming groove 101 and those occurring at the tip of the second trimming groove 104 extend toward the direction between the electrodes, they have less influence on the resistance value. Furthermore, since the influence of the microcracks occurring at the tip of the first trimming groove 101 is prevented by the second trimming groove 104, it is possible to reduce the influence on the electric characteristics and durability due to the microcracks.

### CITATION LIST

### Patent Literature

Patent Literature 1: JP H4-196502 A

Patent Literature 2: JP 2000-340401 A

### SUMMARY OF INVENTION

### Technical Problem

In the resistor 100 described in Patent Literature 2, the length of the vertical direction cut parts and that of the lateral direction cut parts of the first and second trimming grooves 101, 104 are respectively determined based on a ratio to a final target resistance value of the resistor 100. For example, regarding the length of the first trimming groove 101 for coarse adjustment, after a direction of the vertical direction cutting is turned so as to form the L-shape at the point which a resistance value reaches a value of several dozen percent of the target resistance value, the lateral direction cutting is stopped at the point which the resistance value reaches a value obtained by subtracting several percent from the target resistance value. However, the total length of the lateral direction cut part of the first trimming groove 101 is length for which the lateral direction cut part extends until the resistance value reaches the value obtained by subtracting several percent from the final target resistance value, and thus it varies depending on the thickness, material, etc. of the resistor 100. Accordingly, depending on the length of the lateral direction cut part of the first trimming groove 101, a situation where resistance value adjustment with high precision by the second trimming groove 104 cannot be performed may occur.

For example, as illustrated in FIG. 8A, when the total length of the lateral direction cut part of the first trimming groove 101 becomes short, a trimming start point of the second trimming groove 104 may be largely separated from an end of the first trimming groove 101. In such a case, the distance until the tip of the vertical direction cutting of the second trimming groove 104 reaches a continuity line EL1 becomes extremely short. Here, the continuity line EL1 is a virtual line for connecting an intersection point P1, in which on one of the front electrodes 103 is in contact with the lower side of the resistor 100 (illustrated on the left side of FIG. 8A), with an end of the first trimming groove 101 (tip of lateral direction cutting) at the shortest distance, and the second trimming groove 102 is formed in a region Q1 surrounded by the continuity line EL1 and the first trimming groove 101. The region Q1 is a portion where a ratio of the resistance value increment to the amount of cutting-out increment of the second trimming groove 102 is small. However, as described above, when the distance until the tip of the vertical direction cutting of the second trimming groove 104 reaches the continuity line EL1 is short, the distance in which the resistance value can be adjusted is shortened, and as a result, fine adjustment of the resistance value does not work.

Furthermore, as illustrated in FIG. 8B, when the total length of the lateral direction cut part of the first trimming groove 101 becomes long, the end of the first trimming groove 101 may exceed the trimming start point of the second trimming groove 104. In such a case, the change in the resistance value per unit length in the vertical direction cutting of the second trimming groove 104 becomes extremely small, and if the vertical direction cutting of the second trimming groove 104 is extended until the resistance value reaches a resistance value obtained by subtracting one percent from the target resistance value, the tip of the vertical direction cutting of the second trimming groove 104 exceeds the region Q1 and goes through the lateral direction cutting of the first trimming groove 101. As a result, the resistance value of the resistor 100 sharply increases and thus fine adjustment does not work, and moreover, the influence of the microcracks occurring at the tip of the vertical direction cutting of the second trimming groove 104 is increased

The present invention has been made in view of the situations of the prior art, and an objective thereof is to reduce adverse influence on the characteristics due to microcracks, as well as to provide a method of manufacturing a chip resistor capable of performing stable adjustment of a resistance value with high precision by a second trimming groove for fine adjustment.

### Solution to Problem

In order to achieve the above objective, a method of manufacturing a chip resistor according to the present invention comprises: an electrodes forming step of forming a pair of electrodes on a front surface of an insulating substrate with a predetermined interval therebetween; a resistor forming step of forming a rectangular parallelepiped resistor so as to connect the pair of electrodes; a first trimming forming step of measuring a resistance value of the resistor, forming a first cutting-out which extends from one of the side faces of the resistor toward a direction orthogonal to a direction between the electrodes until a measured resistance value reaches a first target resistance value that is higher than an initial resistance value but lower than a target resistance value, and then forming a second cutting-out which extends from an end of the first cutting-out toward the direction between the electrodes by a certain distance L1 so as to form an L-shaped first trimming groove; and a second trimming forming step of measuring the resistance value of the resistor, forming a third cutting-out which extends from one of the side faces of the resistor on which the first trimming groove is formed toward the direction orthogonal to the direction between the electrodes until the measured resistance value reaches a second target resistance value that is higher than the resistance value after the first trimming forming step is performed but lower than the target resistance value, and then forming a fourth cutting-out which extends from an end of the third cutting-out toward the first cutting-out of the first trimming groove until the measure resistance value reaches the target resistance value so as to form an L-shaped second trimming groove, wherein the third cutting-out of the second trimming groove extends from a position on one of the side faces of the resistor, which is a trimming start point separated from the first cutting-out of the first trimming groove toward a direction to one of the electrodes by a certain distance L2 that is longer than the certain distance L1, toward the direction orthogonal to the direction between the electrodes.

According to the method of manufacturing a chip resistor of the present invention, the length of the second cutting-out of the first trimming groove for coarse adjustment after L-shaped direction turning is set to be the certain length L1 irrespective of the thickness, material, etc. of the resistor, and furthermore, the trimming start point of the second trimming groove for fine adjustment is determined at a position which is constantly separated from the first cutting-out of the first trimming groove only by the certain distance L2. Therefore, the end position of the first trimming groove is prevented from being separated too far from nor too close to the trimming start point of the second trimming groove, and thereby it is possible to stably adjust the resistance value with high precision.

Furthermore, according to the method of manufacturing a chip resistor of the present invention, the first target resistance value for determining a turn position of the first trimming groove may be constantly the same value, on the other hand, if predicting the amount of change in the resistance value in accordance with the amount of cutting-out of the second cutting-out to set the first target resistance value to be a predetermined value corresponding to the initial resistance value, even when the initial resistance value greatly fluctuates, the resistance value after forming the second cutting-out does not exceed the target resistance value, and thus it is possible to surely perform fine adjustment of the resistance value by the second trimming groove.

Still further, according to the method of manufacturing a chip resistor of the present invention, when the third cutting-out of the second trimming groove is formed so as to exceed a virtual line connecting an intersection point, in which one of the electrodes is in contact with one of the side faces of the resistor, with the end of the first trimming groove but not to exceed the length of the first cutting-out of the first trimming groove, it is possible to effectively reduce the adverse influence due to the microcracks occurring at the tip of the first trimming groove.

### Advantageous Effects of Invention

According to the method of manufacturing a chip resistor of the present invention, it is possible to reduce adverse influence on the characteristics due to microcracks, as well as to perform stable adjustment of a resistance value with high precision by a second trimming groove for fine adjustment.

### BRIEF DESCRIPTION OF DRAWINGS

FIG. 1 illustrates a plan view of a chip resistor according to an embodiment of the present invention.

FIG. 2A-2D explains a process of manufacturing the chip resistor.

FIG. 3A-3D explains a method of trimming the chip resistor.

FIG. 4 illustrates a flowchart showing a method of trimming the chip resistor.

FIG. 5 illustrates a flowchart showing a method of trimming the chip resistor.

FIG. 6 illustrates a plan view of a chip resistor according to a conventional example.

FIG. 7 illustrates a plan view of a chip resistor according to another conventional example.

FIG. 8A,8B explains a problem of the chip resistor illustrated in FIG. 7.

### DESCRIPTION OF EMBODIMENTS

Hereinafter, an embodiment of the present invention will be described with reference to the drawings. As illustrated in FIG. 1, a chip resistor 1 according to the embodiment of the present invention is configured to mainly include a rectangular parallelepiped insulating substrate 2, a pair of front electrodes 3 provided on both ends of a front surface of the insulating substrate 2 in its longitudinal direction, a rectangular resistor 4 provided on the front surface of the insulating substrate 2 so as to connect the pair of front electrodes 3, and a protective film (not illustrated) provided so as to cover the resistor 4. The resistor 4 is provided with a first trimming groove 5 for coarse adjustment of a resistance value and a second trimming groove 6 for fine adjustment thereof. Although not illustrated in the drawings, on a back surface of the insulating substrate 2, a pair of back electrodes is provided so as to correspond to the front electrodes 3, and on both end faces of the insulating substrate 2 in its longitudinal direction, end face electrodes for bridging the front electrodes and the corresponding back electrodes are provided.

The insulating substrate 2 is made of such as ceramic, and obtained from a large-sized substrate (will be described later) which is divided along vertical and lateral division grooves to obtain multi-piece substrates. The front electrodes 3 are obtained by screen-printing, drying and sintering Ag-based paste, and the back electrodes (not illustrated) are obtained in the same way as the front electrodes 3, that is, by screen-printing, drying and sintering the Ag-based paste.

The resistor 4 is obtained by screen-printing, drying and sintering resistor paste such as Cu—Ni or ruthenium oxide. Adjustment of a resistance value of the chip resistor 1 is performed by providing the L-shaped first trimming groove 5 and the L-shaped second trimming groove 6 on the resistor 4 such that they face with each other. The details of the adjustment will be described later.

In this connection, the protective film (not illustrated) is obtained by screen-printing, heating and curing epoxy-based resin paste, and has a function to protect the resistor 4 from an external environment. The end face electrodes are obtained by applying Ag paste on the end faces of the insulating substrate 2 and drying and sintering the applied paste, or sputtering such as Ni/Cr thereon instead of the Ag paste. On each front surface of the end face electrodes, a plating layer such as Ni, Au, or Sn is applied.

Hereinafter, a process of manufacturing the chip resistor 1 configured as above will be described with reference to FIG. 2A-2D.

The first step of the process of manufacturing the chip resistor 1 is to prepare a large-sized substrate from which multi-piece insulating substrates 2 are obtained. In the large-sized substrate, primary division grooves and secondary division grooves are provided in advance to form a grid pattern, and each one of the grids divided by the primary dividing grooves and the secondary dividing grooves serves as a single chip region. FIG. 2A-2D illustrate a large-sized substrate 2A corresponding to a single chip region as a representative, but practically, each step described below are collectively performed with respect to a large-sized substrate corresponding to multi-piece chip regions.

That is, as illustrated in FIG. 2A, after screen-printing Ag-based paste on a front surface of the large-sized substrate 2A, the step of drying and sintering the screen-printed paste is performed to form a pair of front electrodes 3 (front electrodes forming step). Simultaneously with or around the front electrodes forming step, after screen-printing the Ag-based paste on a back surface of the large-sized substrate 2A, the step of drying and sintering the screen-printed paste is performed to form a pair of back electrodes (not illustrated) (back electrodes forming step).

As illustrated in FIG. 2B, the next step is to screen-print resistor paste such as Cu—Ni or ruthenium oxide on the front surface of the large-sized substrate 2A, and then dry and sinter the screen-printed paste to form a rectangular resistor 4 of which both ends in its longitudinal direction respectively overlap with the front electrodes 3 (resistor forming step).

Next, as illustrated in FIG. 2C, after forming a first vertical direction cut part 5a which extends upwardly from a predetermined position on the lower side of the resistor 4, the step of forming a first lateral direction cut part 5b which turns its extending direction to the left from the tip of the first vertical direction cut part 5a to form L-shape and then extends accordingly by a certain distance L1 is performed so as to form an L-shaped first trimming groove 5 on the resistor 4 (first trimming forming step). With the first trimming groove 5, a resistance value of the resistor 4 is coarsely adjusted to a value which is slightly lower than a target resistance value.

Next, as illustrated in FIG. 2D, after forming a second vertical direction cut part 6a extending upwardly from a position of the lower side of the resistor 4 as a trimming start point, which is separated from the first vertical direction cut part 5a of the first trimming groove 5 to the left side by a certain distance L2 (L2>L1), the step of forming a second lateral direction cut part 6b which turns its extending direction to the right from the tip of the second vertical direction cut part 6a to form L-shape and then extends accordingly is performed so as to form a second trimming groove 6 having L-shape which is oriented in the direction opposite to the orientation of the L-shape of the first trimming groove 5 on the resistor 4 (second trimming forming step). At the point which the first trimming groove 5 and the second trimming groove 6 are formed in the aforementioned manner, adjustment of the resistance value of the resistor 4 is completed and the resistance value of the resistor 4 becomes a value nearly close to the target resistance value.

Here, the second trimming groove 6 can be formed in various shape in accordance with purposes, such as I-cut shape extending only toward the direction orthogonal to the direction between the electrodes from the trimming start point. On the other hand, in a case where the second trimming groove 6 is formed in the L-shape which is oriented in the direction opposite to the orientation of the L-shape of the first trimming groove 5, both microcracks, namely, microcracks occurring at the tip of the first trimming groove 5 and those occurring at the tip of the second trimming groove 6, extend toward the direction between the electrodes, and thereby it is possible to more effectively reduce the adverse influence due to the microcracks. Furthermore, when the tip of the L-shaped second trimming groove 6 is formed so as not to exceed the first trimming groove 5, it is possible to effectively reduce the adverse influence due to the microcracks occurring at the tip of the second trimming groove 6, and moreover, when the tip of the second trimming groove 6 extends toward the inside of the L-cut shaped first trimming groove 5, it is possible to reduce the adverse influence due to the microcracks occurring at the tip of the second trimming groove 6.

Next, the step of screen-printing epoxy resin paste over the first trimming groove 5 and the second trimming groove 6 and heating and curing the screen-printed paste is performed so as to form a protective film (not illustrated) for covering the whole of the resistor 4 (protective film forming step).

The steps up to here are collectively performed with respect to the large-sized substrate 2A from which multi-piece insulating substrates are obtained. In the next step, primary break processing for dividing the large-sized substrate 2A into strips along primary division grooves is performed so as to obtain strip-shaped substrates (not illustrated) provided with multi-piece chip regions (primary dividing step). Then, the step of applying the Ag paste on divided surfaces of the strip-shaped substrate and then drying and sintering the applied paste, or sputtering Ni/Cr thereon instead of the Ag paste is performed so as to form end face electrodes (not illustrated) for bridging the front electrodes 3 and the back electrodes (end face electrode forming step).

Thereafter, secondary break processing for dividing the strip-shaped substrate along secondary division grooves is performed to obtain a chip unit having the same dimension as that of the chip resistor 1 (secondary dividing step). The final step is to apply electrolytic plating such as Ni, Au, or Sn on both of the end faces of the insulating substrate 2 in its longitudinal direction for each divided chip unit so as to form an external electrode (not illustrated) for covering the front electrodes 3 exposed from the protective film. In this way, the chip resistor 1 as illustrated in FIG. 1 can be obtained.

Hereinafter, the aforementioned first trimming forming step and the second trimming forming step will be described in detail with reference to FIG. 3A-3D to FIG. 5.

As illustrated in a flowchart of FIG. 4, the first step of the first trimming forming step is to bring a probe (not illustrated) into contact with the pair of front electrodes 3 to measure an initial resistance value R0 of the resistor 4 (S-1). Then, the step of determining a value of a first target resistance value R1 based on the initial resistance value R0 is performed (S-2). For example, when the initial resistance value R0 is a value minus 10% of the target resistance value Rt, the first target resistance value R1 is determined to be a value minus 3% of the target resistance value Rt, and when the initial resistance value R0 is a value minus 30% of the target resistance value Rt, the first target resistance value R1 is determined to be a value minus 5% of the target resistance value Rt.

Next, while measuring the resistance value R of the resistor 4 by bringing the probe into contact with the pair of front electrodes 3 (S-3), the step of scanning of a laser light is performed along the Y1 direction from the start point coordinates (x0, y0) illustrated in FIG. 3A-3D (S-4). As a result, as illustrated in FIG. 3A, the first vertical direction cut part 5a extending upwardly from the lower side of the resistor 4 is formed (S-5), and the measured resistance value R of the resistor 4 gradually increases in accordance with the amount of cutting-out of the first vertical direction cut part 5a.

Then, when the measured resistance value R of the resistor 4 reaches the first target resistance value R1 (S-6), the step of turning a direction of the laser light to the left side at the angle of 90° from the position above as turn coordinates (x0, y1) and then scanning of the laser light in the X2 direction (S-7) is performed. Thereby, as illustrated in FIG. 3B, the first lateral direction cut part 5b extending toward the left direction from the tip of the first vertical direction cut part 5a is formed (S-8), and the resistance value of the resistor 4 gradually and slightly increases in accordance with the amount of cutting-out of the first lateral direction cut part 5b.

When the first lateral direction cut part 5b extends from the tip of the first vertical direction cut part 5a by the certain distance L1, that is, when an irradiation position of the laser light reaches coordinates (x0+L1, y1) which move from the turn coordinates (x0, y1) by the certain distance L1 in the X2 direction (S-9), irradiation of the laser is finished at the position above so as to form the L-shaped first trimming groove 5 (S-10). At the point which the first trimming groove 5 for coarse adjustment is formed in the aforementioned manner, the resistance value of the resistor 4 is coarsely adjusted to be a second target resistance value R2 which is higher than the first target resistance value R1 but lower than the target resistance value Rt. In this connection, the step for covering the surface of the resistor 4 with a pre-coat layer made of such as glass paste and irradiating of the laser light onto the pre-coat layer may be performed to form the first trimming groove 5 on the resistor 4.

Here, the amount of change in the resistance value in accordance with the cutting-out distance L1 of the first lateral direction cut part 5b varies depending on a position (turn position) of the tip of the first vertical direction cut part 5a, and as the turn position approaches the upper side of the resistor 4, the amount of change in the resistance value in accordance with the cutting-out distance L1 of the first lateral direction cut part 5b increases. As described above, in the present embodiment, the value of the first target resistance value R1 is determined to be smaller as the difference of the initial resistance value R0 with respect to the target resistance value Rt is larger, and thus even when the initial resistance value R0 greatly fluctuates with respect to the target resistance value Rt, by extending and forming the first lateral direction cut part 5b only by the certain distance L1, it is possible to surely perform coarse adjustment so that the resistance value of the resistor 4 becomes the second target resistance value R2.

Thereafter, as illustrated in a flowchart of FIG. 5, the step of determining start coordinates of laser light irradiation which serve as a trimming start point of the second trimming groove 6 based on the position of the first vertical direction cut part 5a of the first trimming groove 5 is performed. The start coordinates of laser light irradiation is set to be on a position (x0+L2, y0) separated from the start point coordinates (x0, y0) in the left direction (X2 direction) by a certain distance L2 (S-11).

In the next step, while measuring the resistance value R of the resistor 4 by bringing the probe into contact with the pair of front electrodes 3 (S-12), the step of scanning of the laser light is performed along the Y1 direction from the start coordinates of laser light irradiation (x0+L2, y0) (S-13). As a result, as illustrated in FIG. 3C, the second vertical direction cut part 6a extending upwardly from the lower side of the resistor 4 is formed (S-14), and the measured resistance value R of the resistor 4 further increases in accordance with the amount of cutting-out of the second vertical direction cut part 6a. At this time, the second vertical direction cut part 6a is formed so as to extend toward a continuity line EL1 connecting an intersection point P1 in which one of the front electrodes 3 is in contact with the lower side of the resistor 4 (illustrated on the left side of FIG. 3C), with an end of the first lateral direction cut part 5b of the first trimming groove 5 at the shortest distance.

When the measured resistance value R of the resistor 4 reaches a third target resistance value R3 which is higher than the second target resistance value R2 but lower than the target resistance value Rt (S-15), the step of turning the direction of the laser light to the right side at the angle of 90° and scanning of the laser light in the X1 direction is performed (S-16). As a result, as illustrated in FIG. 3D, the second lateral direction cut part 6b extending toward the right direction from the tip of the second vertical direction cut part 6a is formed (S-17), and the resistance value of the resistor 4 further gradually and slightly increases in accordance with the amount of cutting-out of the second lateral direction cut part 6b.

Then, when the measured resistance value R of the resistor 4 reaches the target resistance value Rt (S-18), irradiation of the laser is finished at the position above to form the second trimming groove 6 (S-19). In this way, all the steps of trimming the resistor 4 are completed.

As described above, in the method of manufacturing the chip resistor 1 according to the present embodiment, when the first trimming groove 5 for coarse adjustment is formed, the length of the first lateral direction cut part 5b (second cutting-out) of the first trimming groove 5 after L-shaped direction turning is set to be the certain length L1 irrespective of the thickness, material, etc. of the resistor 4, and furthermore, the trimming start point of the second trimming groove 6 for fine adjustment is determined at a position which is constantly separated from the first vertical direction cut part 5a (first cutting-out) of the first trimming groove 5 only by the certain distance L2. Accordingly, the end position of the first trimming groove 5 is prevented from being separated too far from nor too close to the trimming start point of the second trimming groove 6, and thereby it is possible to perform stable adjustment of the resistance value with high accuracy.

Furthermore, in the present embodiment, the amount of change in the resistance value in accordance with the amount of cutting-out of the first lateral direction cut part 5b (second cutting-out) of the first trimming groove 5 after L-shaped direction turning is predicted to set the first target resistance value R1 to be a predetermined value corresponding to the initial resistance value R0. Accordingly, even when the initial resistance value R0 greatly fluctuates, it is possible to surely perform coarse adjustment of the resistance value by the first trimming groove 5.

In the present embodiment, the second vertical direction cut part (third cutting-out) 6a of the second trimming groove 6 is formed so as not to exceed the virtual line EL1 connecting the intersection point P1, in which one of the electrodes 3 is in contact with one of the side faces of the resistor 4, with the end of the first trimming groove 5. On the other hand, it may be configured such that the second vertical direction cut part 6a of the second trimming groove 6 extends to a position exceeding the virtual line EL1 but not to exceed the length of the first vertical direction cut part (first cutting-out) 5a of the first trimming groove 5. With this configuration, influence of microcracks occurring at the tip of the first trimming groove 5 is prevented by the second vertical direction cut part 6a of the second trimming groove 6, and thereby it is possible to effectively reduce the adverse influence due to the microcracks occurring at the tip of the first lateral direction cut part 5b of the first trimming groove 5.

### REFERENCE SIGNS LIST

1 chip resistor
2 insulating substrate
3 front electrode
4 resistor
5 first trimming groove
5a first vertical direction cut part (first cutting-out)
5b first lateral direction cut part (second cutting-out)
6 second trimming groove
6a second vertical direction cut part (third cutting-out)
6b second lateral direction cut part (fourth cutting-out)
EL1 continuity line
Q1 region

1. A method of manufacturing a chip resistor, the method comprising:
an electrodes forming step of forming a pair of electrodes on a front surface of an insulating substrate with a predetermined interval therebetween;
a resistor forming step of forming a rectangular parallelepiped resistor so as to connect the pair of electrodes;
a first trimming forming step of measuring a resistance value of the resistor, forming a first cutting-out which extends from one of the side faces of the resistor toward a direction orthogonal to a direction between the electrodes until a measured resistance value reaches a first target resistance value that is higher than an initial resistance value but lower than a target resistance value, and then forming a second cutting-out which extends from an end of the first cutting-out toward the direction between the electrodes by a certain distance L1 so as to form an L-shaped first trimming groove; and
a second trimming forming step of measuring the resistance value of the resistor, forming a third cutting-out which extends from one of the side faces of the resistor on which the first trimming groove is formed toward the direction orthogonal to the direction between the electrodes until the measured resistance value reaches a second target resistance value that is higher than the resistance value after the first trimming forming step is performed but lower than the target resistance value, and then forming a fourth cutting-out which extends from an end of the third cutting-out toward the first cutting-out of the first trimming groove until the measure resistance value reaches the target resistance value so as to form an L-shaped second trimming groove,
wherein the third cutting-out of the second trimming groove extends from a position on one of the side faces of the resistor, which is a trimming start point separated from the first cutting-out of the first trimming groove toward a direction to one of the electrodes by a certain distance L2 that is longer than the certain distance L1, toward the direction orthogonal to the direction between the electrodes.

2. The method of manufacturing a chip resistor according to claim 1, wherein a value of the first target resistance value is determined in accordance with an initial resistance value.

3. The method of manufacturing a chip resistor according to claim 1, wherein the third cutting-out of the second trimming groove is formed so as to exceed a virtual line connecting an intersection point, in which one of the electrodes is in contact with one of the side faces of the resistor, with an end of the first trimming groove, and so as not to exceed a length of the first cutting-out of the first trimming groove.

4. The method of manufacturing a chip resistor according to claim 2, wherein the third cutting-out of the second trimming groove is formed so as to exceed a virtual line connecting an intersection point, in which one of the electrodes is in contact with one of the side faces of the resistor, with an end of the first trimming groove, and so as not to exceed a length of the first cutting-out of the first trimming groove.
